(19) United States
(12) Patent Application Publication
(10) Pub. No.: US 2016/0375869 A1
(43) Pub. Date: Dec. 29, 2016

(54) MEMBER FOR A SYSTEM CONNECTING A WINDSCREEN WIPER TO MULTIPLE WINDSCREEN WIPER ARMS

(71) Applicant: Valeo Systèmes d'Essuyage, Le Mesnil Saint Denis (FR)

(72) Inventors: Vincent Gaucher, Ennezat (FR); Guillaume Mouleyre, Saint Genes Champanelle (FR)

(73) Assignee: Valeo Systèmes d'Essuyage, Le Mesnil Saint Denis (FR)

(21) Appl. No.: 15/193,165

(22) Filed: Jun. 27, 2016

(30) Foreign Application Priority Data
Jun. 29, 2015 (FR) 1556020

(51) Int. Cl. B60S 1/40

(52) U.S. Cl. CPC B60S 1/40

(57) ABSTRACT

Member (10) for a connecting system between a windscreen wiper assembly (12) and an arm (22) driving the said windscreen wiper assembly, the said member (10) comprising a first retractable securing means (28) configured to act together with an arm (22) having a terminal part (20) of a first type and supported by at least one first flexible resilient pad (32), comprising a first notch (40), the said member (10) comprising at least a second retractable securing means (38) configured to act together with an arm (36) having a terminal part (34) of a second type, characterised in that the second securing means (38) at least partly extends within the first notch (40) of the first resilient pad (32).

### TECHNICAL FIELD

This invention relates to a member for a windscreen wiper connection system, in particular for a motor vehicle.

### STATE OF THE ART

Motor vehicles are conventionally fitted with windscreen wipers to wash the windscreen and prevent the driver's view of his environment from being disturbed. These windscreen wipers generally include a driving arm performing an angular back-and-forth movement and elongated assemblies which themselves carry wiper blades of a resilient material. These blades rub against the windscreen and remove water, taking it out of the drivers field of view. Wiper assemblies are constructed in the form of either, in a conventional version, articulated brackets which hold the wiper blade at several individual points imparting a curvature enabling it to match any curvature in the windscreen, or, in a more recent version known as “flat blade”, a semi-rigid assembly which holds the wiper blade over its entire length by means of one or more curved ribs through which the wiper blade can be applied to the windscreen without having to make use of any brackets.

In the two solutions the wiper is attached to the driving arm by a connection system comprising a connector and an adapter. The connector is a component which is of one piece with the wiper and is generally attached directly to the wiper blade or to the flat structure of the wiper, whereas the adapter is located between the connector and the arm. The adapter is an intermediate part providing a connection and attachment for the connector onto the driving arm, which is secured into a terminal part of the driving arm through the intermediary of retractable securing means,

In the present art there are but few varieties of adaptors which can adapt selectively to several varieties of terminal or end parts of different types of driving arms, which is neither practical nor economic. This state of affairs is an intrinsic result of the design of the resilient return of the securing means. This in fact is generally in the shape of securing buttons mounted at the end of resilient pads and intended to clip into corresponding openings in the terminal parts of the arms.

There are different types of arms, each of which have different terminal parts in which there are openings of different size and/or in different positions.

As the adapters are generally of small size, the overall longitudinal space occupied by the buttons and their resilient pads generally makes it impossible to provide several securing buttons on the top surface of the adapter, which limits the number of possible different terminal parts for which the adapter can be intended.

Furthermore, the adapter must fulfil other functions, in particular that of ensuring that the arm, and consecutively the connector, can pivot in relation to the adapter. For this purpose the cavity bounded by the base and two side walls must be sufficient to house a connector that is of one part with the wiper.

There is therefore a real need for a universal adapter which can be mounted on at least two or even more terminal parts of wiper arms of different types, the said terminal parts each having an opening whose size and/or positioning is specific to the said terminal part.

Such a solution will thus be particularly advantageous and economical.

### DESCRIPTION OF THE INVENTION

In order to satisfy this need the invention provides a member for a system connecting a windscreen wiper to a drive arm for the said windscreen wiper comprising a large number of attachment means, and in particular a large number of securing buttons.

With this aim the invention provides a member for a connection system between a windscreen wiper and a driving arm for the said windscreen wiper, the said member comprising at least a first retractable securing means configured to act together with an arm having a terminal part of a first type, the said first securing means being supported by at least one first resilient pad, the said first resilient pad comprising at least one first notch, the said member comprising at least a second retractable securing means configured to act together with an arm having a terminal part of a second type, characterised in that the second securing means extends at least partly into the first notch.

Through this configuration two securing means, for example two buttons, can be bested on the top surface of the member, occupying less longitudinal space.

In the description below the resilient or flexible nature of the pads constituting the securing means indicates that they are configured so that they are resiliently deformable, that is to say they are capable of resuming their initial position, known as the resting position, on receiving a controlling force corresponding to a starting operation.

According to other characteristics of the invention

the second retractable securing means comprise at least one second resilient pad,

the terminal part of a second type differs from the terminal part of the first type at least in that one opening, for example provided on the top surface of the terminal part, is of specific size and/or in as specific position;

at least one part of the second resilient pad extends into the first notch,

the first resilient pad comprises at least two arms connected to a body of the member which at least partly delimit the first notch,

the member has a substantially longitudinal orientation and comprises at least one body having a substantially U-shaped cross-section comprising at least one base and two side walls, and the resilient pad, known as the first pad, of the first securing means and the second resilient pad, referred to as the second pad, of the second securing means extend along the plane of the base of the said body,

the member is configured so that it is fitted by a translational movement in a longitudinal direction into the first type of terminal part,

the member is configured so that it is fitted by a translational movement in a longitudinal direction into a second type of terminal part,

the first securing means comprises a first button located at a distal extremity of the first resilient pad, the said scouring means being housed in an opening formed in the base of the body,

the second resilient pad extends at least partly opposite the opening,

the second securing means comprises a second button formed at a distal extremity of the second resilient pad,

the member comprises a third retractable securing means configured so as to act together with an arm having a terminal part of a third type, the said third securing means being housed in a second notch formed in the base of the body and being supported by a third flexible resilient pad which extends from an inner surface of one of the side walls of the body,

the opening, the first and second notches and the first and second resilient pads extend along a longitudinal orientation of the member,

the body comprises a first extremity through which it can be introduced into each terminal part, and a second extremity opposite the first extremity,

the first securing means is closer to the first extremity of the body of the member than the second securing means,

the first, second and third securing means are longitudinally aligned between the first and second extremities,

the member comprises a fourth securing means configured so as to act together with an arm having a terminal part of a fourth type, the said fourth securing means being supported by at least a fourth resilient pad extending from the first extremity as a prolongation of at least one of the side walls of the body,

the member comprises a head formed at the second extremity of the member,

a housing receiving at least one of the terminal parts of the arm is located between the body and at least one lateral wing of the body issuing from the head,

the opening opens at or at the same level as the first extremity of the body.

The invention finally relates to a windscreen wiper comprising a member of the type described above.

### DESCRIPTION OF THE FIGURES

The invention will be better understood and other details, characteristics and advantages of the invention will be apparent from a reading of the following description provided by way of a non-limiting example with reference to the appended drawings in which:

FIG. 1 is a diagrammatical perspective view of a windscreen wiper, this windscreen wiper comprising a wiper blade, an arm driving the blade and a system for connecting the wiper blade to the arm,

FIGS. 2A and 2B are perspective views of a member according to the invention from above;

FIG. 3 is a perspective view of a member according to the invention from below,

FIGS. 4 to 9 are respective perspective views of the terminal parts of the first to sixth arms intended to act together with the member according to the invention,

FIGS. 10 to 15 are assembled perspective views from above of the member and the terminal parts of the first to sixth arms according to the invention,

FIG. 16 is a perspective assembled view of the member and the terminal part of the first arm according to the invention from below.

### DETAILED DESCRIPTION

In the following description the same reference numbers will indicate parts that are identical or have similar functions.

It will be noted that the figures illustrate the invention in a detailed manner so that the invention can be implemented, the said figures being of course capable of better defining the invention as appropriate.

Also, in the description below the terms longitudinal or lateral refer to the orientation of the windscreen wiper blade or the driving arm according to the invention. The longitudinal direction corresponds to the principal axis of the windscreen wiper blade, whereas the transverse and vertical orientations correspond to intersecting straight lines, that is lines crossing the longitudinal direction, in particular perpendicular to the longitudinal axis of the windscreen wiper blade. For a better understanding of the invention the figures may be orientated with reference to the “X-Y-Z” axes.

Finally, directions referred to as being upper or lower correspond to orientations perpendicular to the plane of rotation of the windscreen wiper blade, the term lower facing the plane of the windscreen and the term upper facing away from that plane.

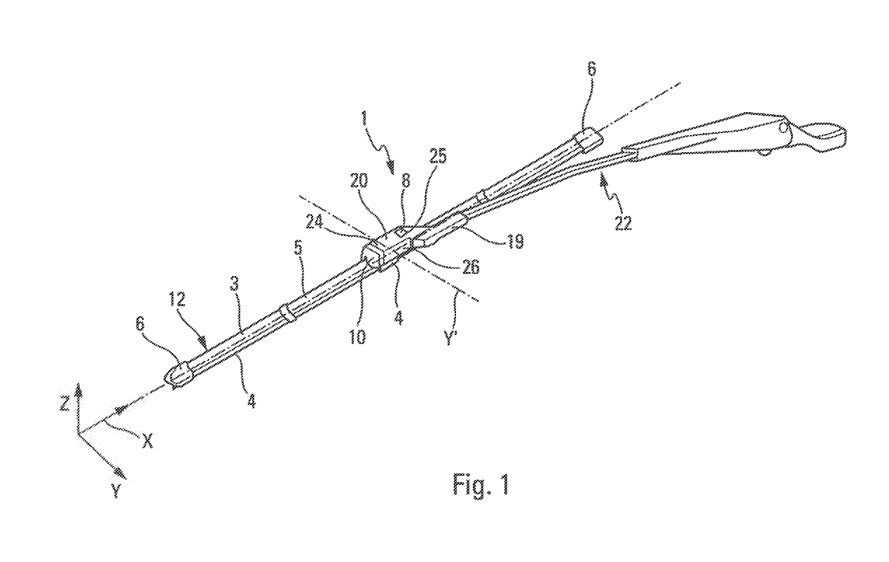

FIG. 1 illustrates a windscreen wiper 1 comprising in particular a windscreen wiper assembly 12 and a driving arm 22 for windscreen wiper assembly 12.

Windscreen wiper assembly 12 is preferably of the flat blade type and comprises a longitudinal body 3 orientated substantially along a longitudinal axis X, a wiper blade 4, generally of rubber or elastomer material, and at least one rib (not seen) which stiffens the blade and helps to apply it to a vehicle windscreen,

Body 3 of windscreen wiper assembly 12 may comprise an upper aerodynamic deflector 5 intended to improve the functioning of the wiper system, the purpose of this deflector being to encourage the windscreen wiper assembly to press against the windscreen and therefore improve the aerodynamic performance of the windscreen wiper.

Windscreen wiper assembly 12 may further comprise end parts 6 or clips attaching blade 4 and the rib to body 3, these end parts 6 being located at each of the longitudinal extremities of body 3.

Windscreen wiper assembly 12 comprises an intermediate connector 4 substantially in its middle. A member 10 forming an adaptor which is of one part with arm 22 is mounted on connector 4 so as to maintain a degree of freedom when pivoting about an axis of rotation Y′ which is a transverse axis parallel to a transverse direction Y substantially perpendicular to the longitudinal axis X of windscreen wiper assembly 12. This degree of freedom allows windscreen wiper assembly 12 to pivot with respect to arm 22 and thus windscreen wiper assembly 12 to follow the curvature of the windscreen as it moves. Member 10 is intended to be configured so as to be fitted by a translational movement in the longitudinal X direction into a terminal part 20 of arm 22, from which it can be detached by pressing on securing means.

Arm 22 is intended to be driven by a motor to follow an angular back and-forth movement which removes water and possibly other undesirable elements covering the windscreen. Adapter 10 provides a connection between windscreen wiper assembly 12 and arm 22 and in particular terminal part 20 of arm 22 which may be formed of a single part with arm 22, or attached and fixed thereto.

In the example illustrated, terminal part 20 of the arm forms a case having a substantially U-shaped transverse cross-section.

Terminal part 20 has an elongated shape whose axis of elongation is generally substantially parallel to or coaxial with the longitudinal axis or axis of elongation X of windscreen wiper assembly 12. In the course of this description, in a manner which is not thus limiting, it will be taken that the axis of elongation of terminal part 20 corresponds to the X axis.

Terminal part 20 comprises a part 19 connected to the remainder of arm 14. This part 19 is of generally elongated shape and extends substantially parallel to the X axis and at a distance from that X axis, as may be seen in FIG. 1. Part 19 is connected to a hinder extremity of the remainder of terminal part 20.

With reference to FIG. 1, terminal part 20 comprises two side walls 26 the upper longitudinal edges of which are connected together by an upper transverse wall 24. Along their lower longitudinal edges side walls 26 and wall 24 delimit between them a space housing adapter 10. Side walls 26 may have retaining means for adapter 10, which are described in greater detail below in this description.

Upper wall 24 may comprise a through opening 25 of a shape matching pushbutton 8. In the assembled position pushbutton 8 is housed in that opening 25 and can pass through it so that it projects beyond the upper surface of wall 24. Pushbutton 8 is fitted into opening 25 by merely engaging or nesting therewith, preferably through resilient clipping.

In this design member 10 can only be mounted on a particular type of arm 22 which has been illustrated, and more particularly on the particular type of corresponding terminal part 20, which is neither practical nor economical because another type of member or adapter 10 has to be used when it is desired to fit windscreen wiper assembly 12 onto a different arm. Member 10 cannot for example be fitted into a terminal part having an opening 25 which is of different size and/or in a different position.

One disadvantage of the systems in the prior art is that in order to be retractable they must be mounted at the end of resilient pads that are generally orientated in the longitudinal direction X. These pads have to be of sufficient length to bend sufficiently and thus have sufficient resilience to allow sufficient vertical movement of the bottom. Now as members and adapters 10 are generally small, the total longitudinal space occupied by the buttons and their resilient pads generally make it impossible to provide a plurality of securing buttons on the upper wall of the adapter, which limits the number of possibilities for the terminal parts for which the adapter may be intended.

There is therefore a real need for a universal adapter which can be fitted selectively onto at least two, or even more, different terminal parts of windscreen wiper arms.

The invention provides for this purpose a member for a connection system between a windscreen wiper assembly and a driving arm for the said wiper comprising a large number of attachment means, and in particular a large number of securing buttons.

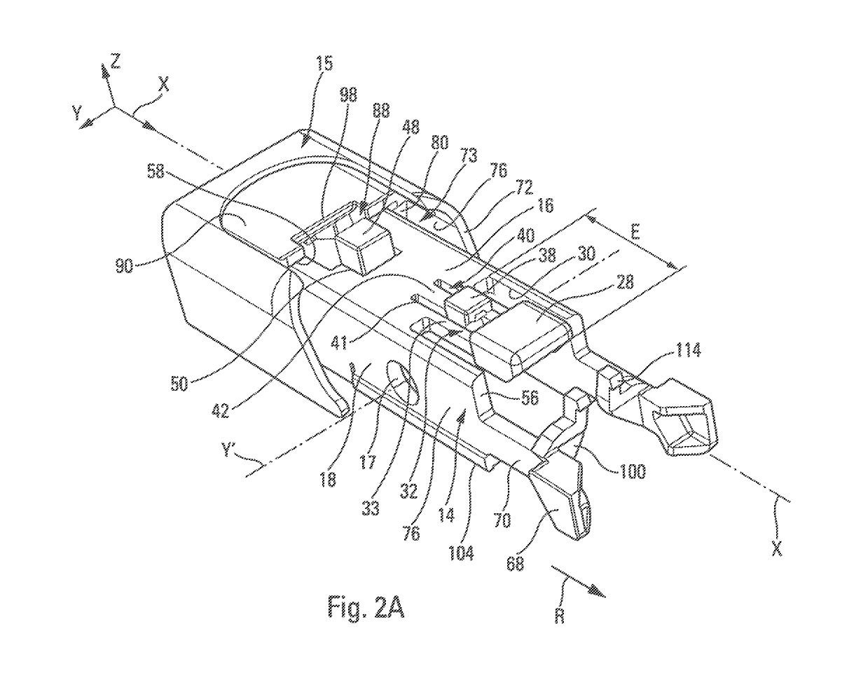

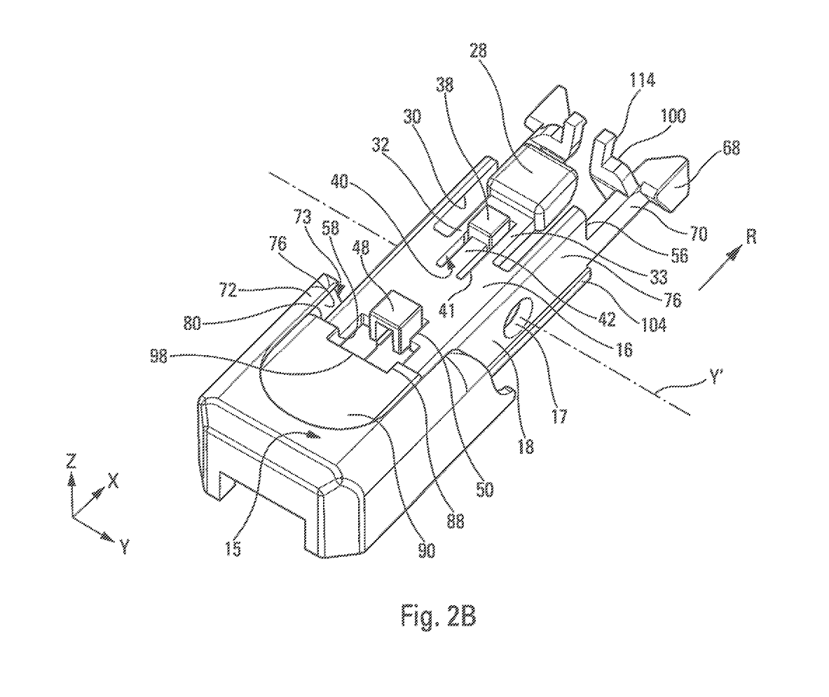

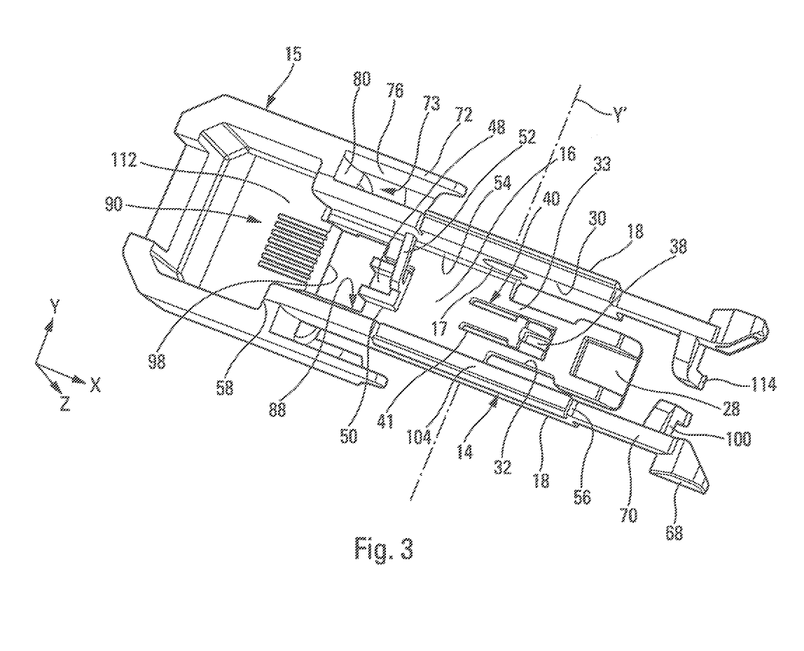

With this object the invention provides a member 10 or adapter for a system connecting a windscreen wiper assembly to a driving arm 22 of the said windscreen wiper assembly 12 constructed in accordance with FIGS. 2A, 2B and 3.

Member 10 has a substantially longitudinal orientation X and comprises at least one body 14 having a substantially U-shaped cross-section. This body 14 comprises an upper wall 16, otherwise referred to as the base, and two side walls 18 which are substantially parallel to each other and substantially perpendicular to base 16. The side walls include for example two openings 17 aligned transversely and intended to constitute pivot axis Y′ of windscreen wiper assembly 12, for example by receiving matching teats (not shown) carried by connector 4.

It will be understood that the pivoting means may have other shapes, for example, and in a manner not limiting the invention, openings intended to receive an axis passing through the connector of the arm or intended to receive bearings projecting from the connector, or non-through bosses intended to receive bearings projecting from the connector to form two connections of the nesting universal joint type by moving side walls 18 of body 14 apart. Alternately the member may comprise two protuberances orientated towards each other and constituting one part with the member. These are then received in cavities provided in the connector.

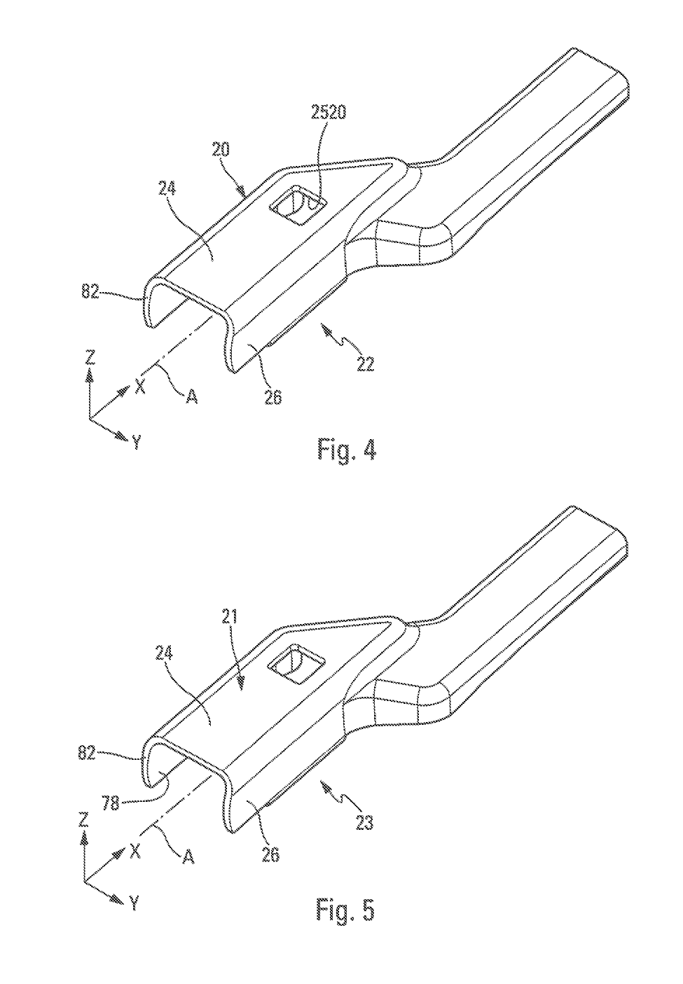

Member 10 is configured so as to be fitted by a translational movement in a longitudinal X direction into a terminal part 20 of first type of arm 22, which in the remainder of this description will be referred to as the first terminal part 20 of first arm 22, as previously illustrated in FIG. 1 and as illustrated in FIG. 4. First terminal part 20 is bounded by an upper wall 24 and two side walls 26 which are substantially parallel to each other and perpendicular to upper wall 24. Such a first terminal part 20 has for example been illustrated in FIG. 4.

As FIGS. 2A and 2B illustrate, body 14 of member 10 according to the invention comprises at least a first securing means 28 configured to act together with said first terminal part 20 of first arm 22. In the preferred embodiment of the invention this first securing means comprises a pushbutton 28 intended to penetrate within an opening 2520 in said first terminal part 20, it will be understood that this configuration is not limiting upon the invention and that first securing means 28 may adopt any other shape intended to ensure its function, such as for example that of a pin or tooth.

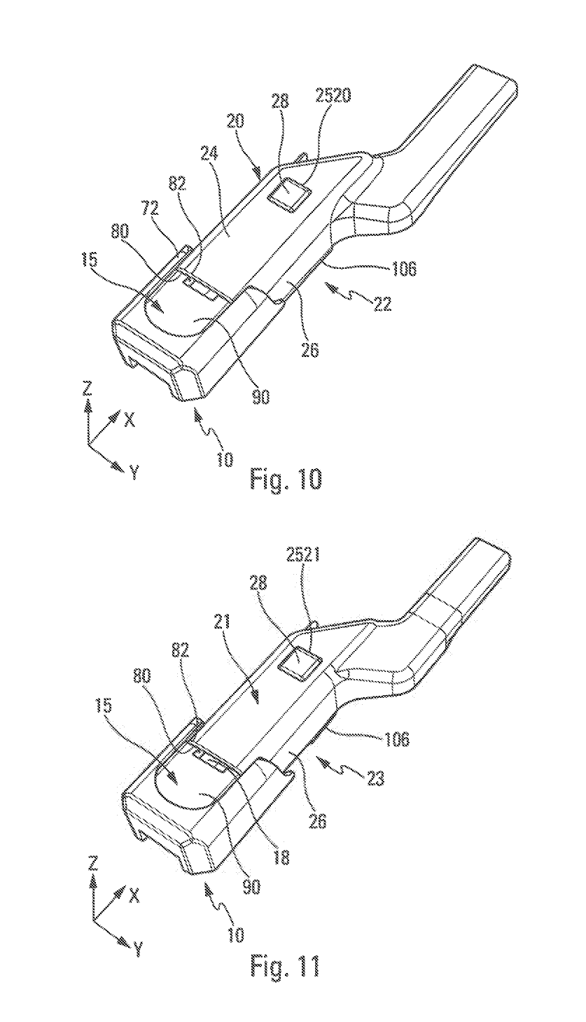

Pushbutton 28 is supported by a first resilient pad 32 which extends at least partly within opening 30 so that the resilient return of pushbutton 28 will enable it to be cupped into opening 2520 of first terminal part 20, as shown in FIG. 10.

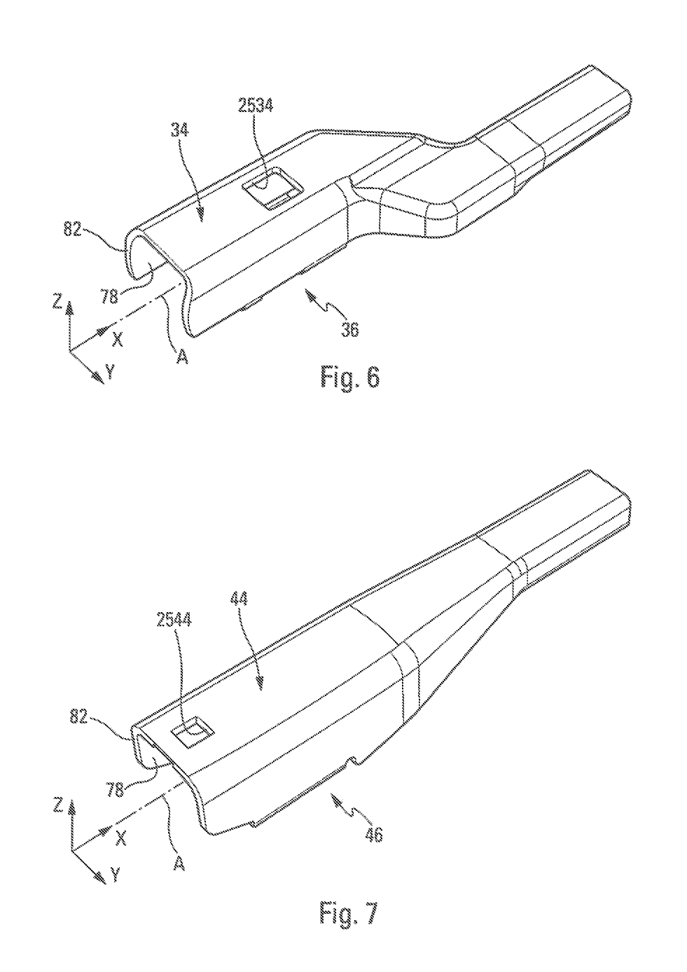

Member 10 is configured so as to be selectively fitted, always through a translational movement in the longitudinal X direction, into a terminal part 34 of at least one arm 38 of another type, as illustrated in FIG. 6. For this purpose it comprises at least a second retractable securing means 38 configured to act together with said terminal part 34 of other arm 36, of a second type different from the first type.

In the preferred embodiment of the invention this second securing means 38 comprises a second pushbutton 38 intended to penetrate and clip into opening 2534 of terminal part 34. It will be understood that this configuration is not limiting upon the invention and that second securing means 38 may adopt any other shape intended to ensure its function, such as for example that of a pin or tooth.

In the previously known configurations in the state of the art a plurality of securing means implies that they must be arranged one after the other so that they take up a significant amount of space in longitudinal direction X. The invention overcomes this disadvantage by providing securing means comprising securing means which are included within each other, so as to occupy less longitudinal space.

For this purpose, as illustrated in particular by FIGS. 2A, 2B and 3, the invention provides a member 10 whose first resilient pad 32 comprises at least a first notch 40. In accordance with the invention second retractable securing means 38 extends at least partly into first notch 40.

Second securing means 38, which is constituted in a non-limiting way by a second pushbutton 38, is supported by at least one second resilient pad 42, which also extends at least partly into first notch 40.

Member 10 may comprise an extension 41 of notch 40 extending into base 16. Second pad 42 may thus extend into second notch 40, and into an extension 41 of first notch 40. Advantageously there is a plane from which it is possible to apply flexion to the securing means, this plane being common to the first and second securing means, that is to say passing through them in the resting position.

As illustrated in FIG. 2A, this configuration makes it possible to provide first and second resilient pad means 32, 42 and associated pushbuttons 28, 38 which occupy a smaller space.

In the preferred embodiment of the invention first resilient pad 32 comprises at least two arms 33 connected to body 14 and member 10, which at least partly delimit first notch 40.

In the preferred embodiment of the invention, first resilient pad 32 of first securing means 28 and second resilient pad 42 of second securing means 38 extend in the plane of base 16 of body 14.

As has been seen, in the preferred embodiment of the invention first securing means 28 comprises a first pushbutton 28. This first pushbutton 28 is located at a distal extremity of first resilient pad 32, which makes it possible to provide maximum flexion for first pushbutton 28. In addition to this first securing means 28 is housed in an opening 30 formed in base 16 of body 14.

It will therefore be understood that each securing means comprises at least one resilient pad at the end of which at least one pushbutton is formed.

In this configuration second resilient pad 42, which extends at least partly into first notch 40, extends at least party opposite opening 30.

In the same way second securing means 38 comprises a second pushbutton 38 formed at a distal extremity of second resilient pad 32, which also makes it possible to provide maximum flexion for second pushbutton 38.

Advantageously opening 30, first notch 40 and first and second resilient pads 32, 42 extend in the longitudinal X direction of member 10 so that first and second resilient pads 32, 42 and associated pushbuttons 28, 38 occupy a small longitudinal space E. This configuration is preferably obtained when first and second resilient pads 32, 42 extend in the same direction R along said longitudinal direction X, for example towards the rear of member 10.

Because of this, base part 16 and member 10 which is not occupied by first and second pads 32, 42 and associated pushbuttons 28, 38 can be provided so as to act together with other types of arms, as will be seen in the remainder of this description.

In the preferred embodiment of the invention member 10 is configured to be fitted by a translational movement in the longitudinal X direction and then secured into first and second terminal parts 20, 21 of arm 22, 23 of the first or second types, the said terminal parts being illustrated in FIGS. 4 and 5, through the intermediary of first button 28, or into a third terminal part 34 of an arm 36 of a third type, as illustrated in FIG. 6, through the intermediary of second button 38.

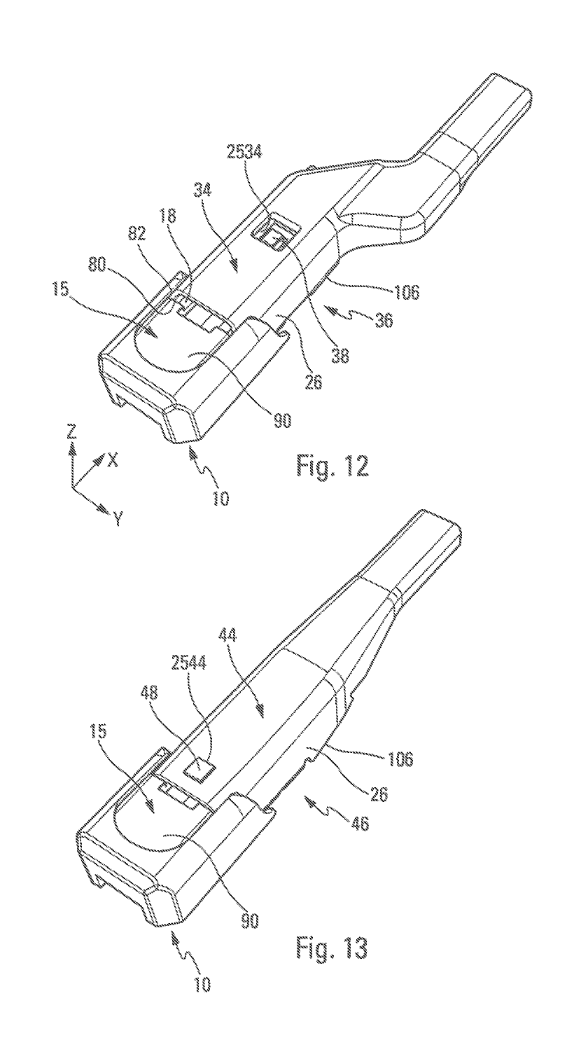

In particular first securing pushbutton 28 is configured to act together with second terminal part 21 by penetrating into an opening 2521 in said second terminal part 21, and second pushbutton 38 is configured to act with third terminal part 34 by penetrating into an opening 2534 in said third terminal part 34, as illustrated in FIGS. 11 and 12 respectively.

In the preferred embodiment of the invention, body 14 has a first extremity 56 through which it can be introduced into each terminal part and a second extremity 58 opposite first extremity 56. Second extremity 58 is in particular adjacent to a head 15 formed at the extremity of member 10.

In this configuration the first securing means, comprising at least first pushbutton 28, is preferably closer to the first extremity 56 of body 14 and member 10 than the second securing means comprising in particular second pushbutton 38. This configuration is not however limiting upon the invention.

It will be noted that the dimensions of first pushbutton 28 are larger than the dimensions delimiting second pushbutton 38.

The first resilient pad of the first securing means extends for example in a plane parallel to the resilient pad of the second securing means. The thickness of the resilient pad of the second securing means is for example equal to or smaller than the thickness of the resilient pad of the first securing means, the second resilient pad being then contained within the dimensions of the first resilient pad.

As has been seen, the part of base 16 of member 10 which is not occupied by first and second pads 32, 42 and associated pushbuttons 28, 38 may thus be provided so that it acts together with other types of arm. For this purpose member 10 is configured so as to be fitted by a translational movement in the longitudinal direction into a fourth terminal part 44 of at least one arm 46 of a fourth type, the said fourth terminal part being illustrated in FIG. 4. In this case member 10 comprises at least one retractable securing means 48 comprising, in a manner not limiting upon the invention, a third securing pushbutton 48 configured to act together with said fourth terminal part 44, said third button 48 being housed in a second notch 50 formed in upper wall 16 of body 14 and supported by a third flexible resilient pad 52 extending transversely with respect to longitudinal direction X from a wall of body 14. Third button 48 is intended to act together with an opening 2544 in fourth terminal part 44 of arm 46 of the fourth type.

As may be envisaged, the transverse arrangement of third resilient pad 52 is particularly advantageous in that it limits the space occupied in longitudinal direction X.

Preferably third resilient pad 52 extends from an inner surface 54 of one of side walls 18 of body 14. This configuration makes it possible to provide a third inclined resilient pad 52 of sufficient length to provide it with flexibility allowing third pushbutton 48 to be manipulated, which would not be the case if the third resilient pad were to be supported on the upper surface 16 of member 10. Third pushbutton 48 is of a size and dimensions intermediate between the first and second pushbuttons.

In the preferred embodiment of the invention first pushbutton 28, second pushbutton 38 and third pushbutton 48 are arranged so that they are aligned in the longitudinal direction X of first extremity 56 of body 14 towards second extremity 58. It should be noted that this arrangement could be reversed without changing the nature of the invention, first pushbutton 28 and second pushbutton 38, which are necessarily attached to each other, being then arranged on the side of second extremity 58 of body 14 and third pushbutton 48 being located on the side of first extremity 56.

It will also be noted that in the preferred configuration of the invention according to which first pushbutton 28 and second pushbutton 38 are located close to first extremity 66 of body 14, opening 30 will open at the first extremity 56 of body 14.

Body 14 being preferably constructed by injection moulding of a plastics material, this configuration will in particular simplify the turning out of said body 14.

The configuration mentioned above makes it possible to optimise the arrangement of the securing means, in particular pushbuttons 28, 38, 48 on base 16 of member 10. However, additional securing means can advantageously be provided by placing them on or in side walls 18.

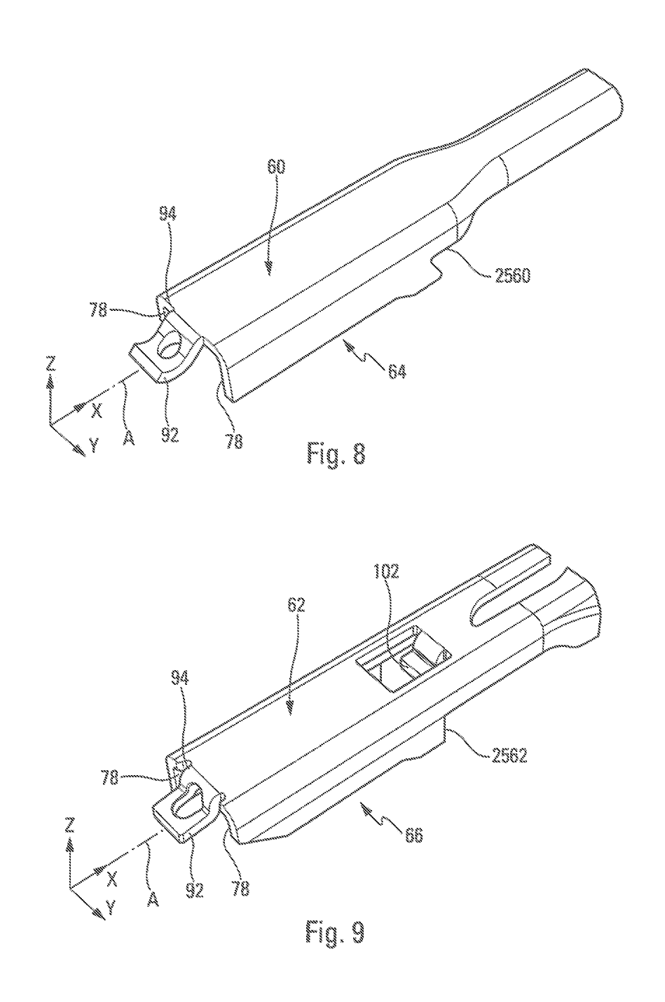

Thus in accordance with the invention member 10 is also configured so as to be fitted by a translational movement in the longitudinal X direction into a third terminal part 60 of an arm 64 of a fifth type and in a sixth terminal part 62 of an arm 66 of a sixth type which have been illustrated in FIGS. 8 and 9. For this purpose member 10 comprises at least two fourth lateral securing pushbuttons 68, transversely opposite to each other, which are configured to act together with fifth and sixth terminal parts 60, 62. In particular fifth terminal part 60 comprises for this purpose two side notches 2560 formed at the extremity of fifth terminal part 60, which match fourth pushbuttons 68. Likewise sixth terminal part 62 comprises for this purpose two lateral notches 2562 formed at the extremity of sixth terminal part 62 which match fourth pushbuttons 68.

Preferably, as illustrated in FIGS. 2A to 3, fourth buttons 68 are supported by fourth resilient pads 70 which extend longitudinally from first extremity 56 of body 14 as an extension of side walls 18 from extremity 56 of body 14. Fourth pads 70 can thus be configured so that they are of great length sufficient to impart the required flexibility to fourth buttons 68. Fourth pushbuttons 68 mentioned here are positioned against a section of the terminal part in question.

In addition to securing buttons 28, 38, 48, 68, member 10 comprises means for transversely holding member 10 in different terminal parts 20, 21, 34, 44, 60, 62 of arms 22, 23, 36, 46, 64, 66 on which it can be mounted.

Thus, as FIGS. 2A to 3 illustrate, member 10 comprises first means for transversely holding first arm 22. These means comprise two wings 72 which extend with play from head 15 in the direction of body 14 parallel to side was 18 of said body 14 and which provide a housing 73 receiving at least one of the terminal parts. For example wings 72 are intended to receive the outer surfaces of side wall 26 of first terminal part 20 of first arm 22 against their inner surfaces 74, as shown in FIG. 10.

Likewise, side walls 18 and member 10 comprise flat external surfaces 76 forming second means for transversely holding member 10 in relation to second and sixth terminal parts 21, 34, 44, 60, 62 of arms 23, 36, 46, 64, 66 of the second to sixth types. Walls 18 are intended to receive the inner surfaces 78 of side walls 26 of second to sixth terminal parts 21, 34, 44, 60, 62. These walls have been illustrated in FIGS. 5 to 9.

It will be noted that a distance measured perpendicularly to side walls 26 and between these is the same for the terminal parts of the first type and second type referenced 20 and 21. This distance is for example 22 mm. At the end of each lateral wall these terminal parts 20 and 21 have an edge folded in the direction of the opposite lateral wall. Terminal part 21 of the second type is distinguished from terminal part 20 of the first type by the fact that at least one of the folded edges, and for example both, is interrupted, in other words discontinuous. In other words, several folded edges are provided at the end of each side wall of terminal part 21 of the second type.

Third terminal part 34 differs from second terminal part 21 only in the distance measured perpendicularly to side walls 26 and separating the latter. Here this is 19 mm.

In addition to the securing means and the transverse holding means, member 10 comprises longitudinal stop means for the different terminal parts of the arms onto which it can be fitted.

Head 15 of member 10 occupies more transverse space in the Y direction than body 14. Because of this, together with body 14, it bounds transverse faces 80 formed at the junction of body 14 and head 15, at the base of housings 73, these transverse faces 80 being formed at the junction of body 14 and head 15 and extending transversely from side walls 18 of body 14. These transverse faces 80 are configured so as to receive as a stop one extremity 82 of first to third terminal parts, as illustrated in FIGS. 10 to 12, and in this respect form first longitudinal stop means for first to third terminal parts 20, 21, 34 in the X direction.

Member 10 may comprise other stop means. Thus terminal part 62 of arm 66 of the sixth type comprises a matching pad 102 extending parallel beneath the plane of upper wall 24 of that terminal part 62. In this configuration member 10 comprises two longitudinal stop means for this pad 102 of sixth arm 66. As illustrated in FIGS. 2A to 3, the second stop means comprise two fifth pads 100 extending transversely towards the interior of body 14 from fourth resilient pad 70 to form a stop against matching pad 102 of arm 66 of the sixth type.

In addition to securing means 28, 38, 45, 58, the transverse folding means and the longitudinal stop means, member 10 comprises vertical holding means for member 10 in the terminal parts of different arms 22, 23, 36, 46, 64, 66 in the vertical Z direction.

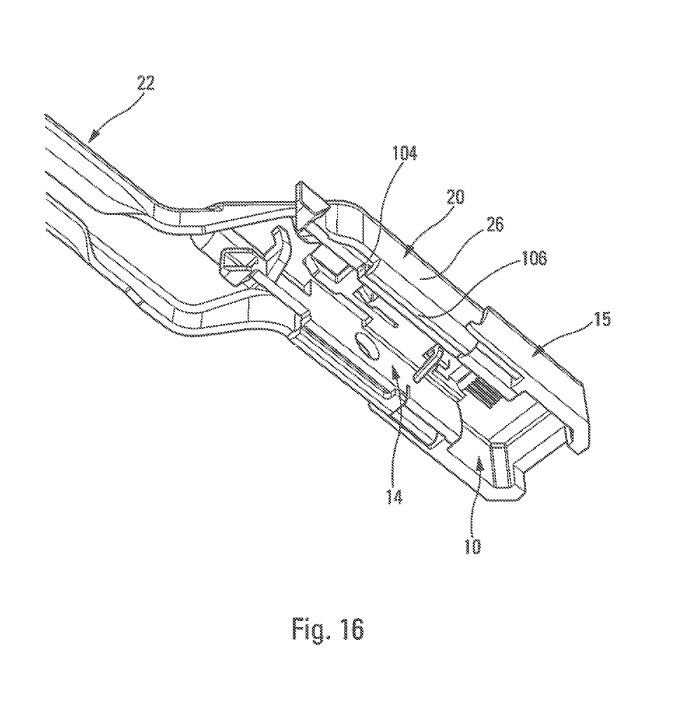

As illustrated in FIGS. 3 and 16, the free lower edges 104 of side was 18 of body 14 form the first vertical retaining means for member 10 in first to fourth terminal parts 20, 21, 34, 44 which are capable of acting together with wings 106 extending inwards from lower edges 108 of side walls 110 of arms 22, 23, 36, 46 of the first to fourth types. This configuration is illustrated by way of example in FIG. 18, which shows that terminal part 20 of first arm 22, whose wings 106 are intended to hold the lower edges 104 of member 10.

Each of the first to fourth terminal parts of arms 22, 23, 36, 46 of the first to fourth types comprise at least two similar wings 106.

Advantageously member 10 can form additional vertical holding means for certain types of terminal parts of arms, in particular for the fifth and sixth terminal parts 60 and 62 of arms 64 and 66 of the fifth and sixth types which incorporate an extremity pad 92 extending from a transverse edge of extremity 94 of upper wall 24 of said terminal parts 60, 62 parallel to said upper wall 24, as illustrated in FIGS. 8 and 9.

Thus member 10 comprises a third notch 88, which straddles upper surface 16 of body 14 and an upper wall 90 of head 15. Notch 88 is configured to receive in a matching way pad 92 of the matching extremity of fifth or sixth terminal parts 60, 62, which is thus capable of extending below the upper wall 90 of head 16 illustrated in FIG. 3.

Second and third notches 50, 88 are preferably adjacent. Preferably, second and third notches 50, 88 communicate with each other to assist turning out of member 10 after it has been moulded by the injection moulding of plastics.

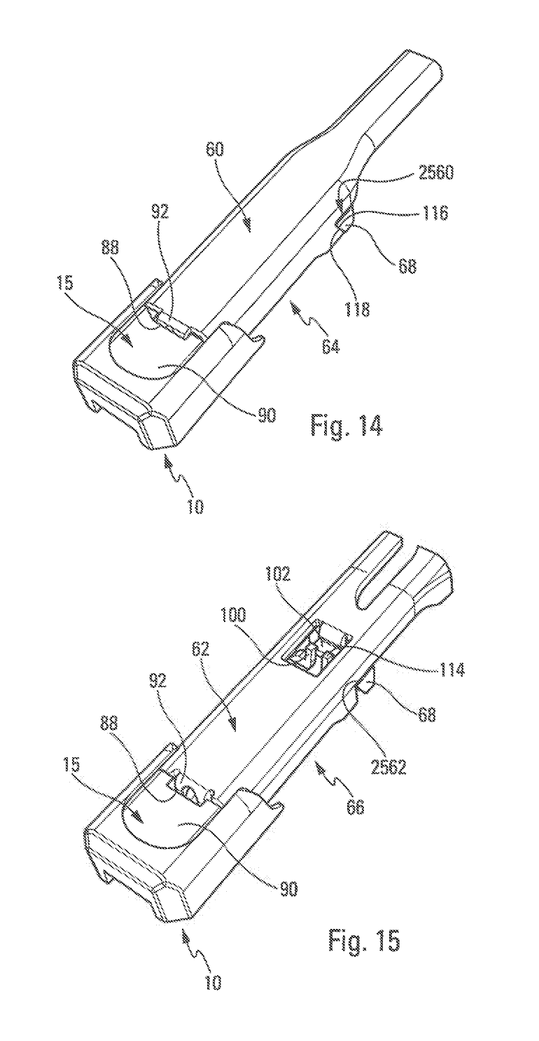

The terminal parts may also be vertically held in a different complementary way, particularly as regards fifth and sixth terminal parts 60, 62. Thus, as illustrated in FIG. 14, edges 116 of fourth lateral securing pushbuttons 68, which are inclined in relation to the vertical, are configured to act together with matching edges 118 of notches 2560 receiving the said fourth buttons 68 formed in fifth terminal piece 60 to form vertical means for holding fifth terminal part 60. Vertical holding is thus in this instance combined with fourth pushbuttons 68.

Likewise vertical holding may be combined with stop buttons. Thus, as illustrated in FIG. 15, upper extremities 114 of fifth pads 100 are in the shape of hooks and intended to act together with matching pad 102 of sixth terminal part 60 of sixth arm 66 extending parallel beneath upper surface 24 of said terminal part 60 so as to form vertical holding means specific to said sixth arm 66.

FIGS. 10 to 16 illustrate different terminal parts 20, 21, 34, 44, 60 and 62 of different arms 22, 23, 36, 46, 60, 66 receiving member 10.

As illustrated in FIG. 10, member 10 is immobilised by side walls 26 of first terminal part 20 of arm 22 of the first type which are received in housing 73 between wings 72 of member 10, and the longitudinal stop for member 10 is provided by the transverse surfaces 80 of the bottom of housing 73 of member 10 which are received as a stop against extremity 82 of said first terminal part 20. Member 10 is held vertically by wings 106 of first terminal part 20 of first arm 22, and member 10 is secured by first pushbutton 28 which is received in opening 2520 of said terminal part 20.

As illustrated in FIG. 11, member 10 is immobilised by side walls 26 of second terminal part 21 of arm 23 of the second type which receives side was 18 of member 10, and the longitudinal stopping of member 10 is provided by the transverse surfaces 80 of member 10 which are received as a stop against the extremity 82 of said second terminal part 21. Member 10 is held vertically by wings 106 of second terminal part 21 of second arm 23, and member 10 is secured by first pushbutton 28 which is received in opening 2521 of said second terminal part 21.

As illustrated in FIG. 12, member 10 is immobilised by side was 26 of third terminal part 34 of arm 36 of the third type which receives side was 18 of member 10, and longitudinal stopping of member 10 is ensured by the transverse surfaces 80 of member 10 which are received as a stop against the extremity 82 of said third terminal part 36. Member 10 is held vertically by wings 106 of third terminal part 34 of third arm 36, and member 10 is secured by second pushbutton 38 which is received in opening 2534 of said terminal part 34.

As illustrated in FIG. 13, member 10 is immobilised by side walls 26 of fourth terminal part 44 of fourth arm 46 which receive side walls 18 of member 10. Member 10 is held vertically by means of wings 106 of fourth terminal part 44 of fourth arm 46, and member 10 is secured and longitudinally immobilised by third pushbutton 48 which is received in opening 2544 of said fourth terminal part 44.

As illustrated in FIG. 14, member 10 is immobilised by side was 26 of fifth terminal part 60 of fifth arm 64 which receive side was 18 of member 10. Longitudinal stopping of member 10 is ensured by the transverse surfaces 80 of member 10 which are received as a stop against extremity 82 of said fifth terminal part 60. Member 10 is secured by fourth lateral buttons 68 which are received in notches 2560, and member 10 is held vertically by the inclined edges 116 of fourth pushbuttons 68 which act together with matching edges 118 of notches 2560 receiving said fourth buttons 68, and by fourth notch 88 which receives extremity pad 92 of fifth terminal part 60 of fifth arm 64. Longitudinal stopping of member 10 may also be ensured partly by fourth notch 88 which receives extremity pad 92 of fifth terminal part 60 of fifth arm 64.

Finally, as illustrated by FIG. 15, member 10 is immobilised by side walls 26 of sixth terminal part 62 of sixth arm 66 which receive side walls 18 of member 10, and longitudinal stopping of member 10 is ensured by fifth pad 100 of member 10 which extend in contact with matching pad 102 of sixth arm 66 extending parallel beneath upper wall 24 of said sixth arm 66.

Member 10 is secured by fourth lateral buttons 68 which are received in notches 2562, and member 10 is held vertically by extremity pad 92 extending beneath upper wall 80 of head 15 by hook extremities 114 of fifth pads 100, pads which act together with matching pad 102 of sixth arm 66 extending parallel beneath upper wall 24 of said sixth arm 66.

The invention thus provides a member 10 forming an adapter which can act together selectively with many terminal parts of a windscreen wiper arm, through which the fitting of windscreen wiper assembly 12 on different arms 22, 23, 38, 46, 64, 66 is considerably simplified.

1. A member for a connection system between a windscreen wiper assembly and an arm driving the windscreen wiper assembly, the member comprising:
at least a first retractable securing means configured to act together with an arm having a terminal part of a first type, the securing means being supported by at least one first resilient pad, the first resilient pad comprising at least a first notch; and
at least a second retractable securing means configured to act together with an arm having a terminal part of a second type,
wherein the second securing means at least partly extends into the first notch of the first resilient pad.

2. The member according to claim 1, wherein the second retractable securing means comprises at least one second resilient pad.

3. The member according to claim 2, wherein at least part of the second resilient pad extends into the first notch.

4. The member according to claim 2, wherein the first resilient pad has at least two arms connected to a body of the member which at least partly delimit the first notch.

5. The member according to claim 2, wherein the member is substantially orientated longitudinally and further comprises at least one body of substantially U-shaped cross-section comprising at least one base and two side walls, wherein the resilient pad, referred to as the first pad, of the first securing means and the second resilient pad, referred to as the second pad, of the second securing means, extend in the plane of the base of the body.

6. The member according to claim 2, wherein the first securing means comprise a first pushbutton located at a distal extremity of the first resilient pad, the first securing means being housed in an opening formed in the base of the body.

7. The member according to claim 6, wherein the second resilient pad at least partly extends opposite the opening.

8. The member according to claim 2, wherein the second securing means comprises a second pushbutton formed at a distal extremity of the second resilient pad.

9. The member according to claim 5, further comprising
a third retractable securing means configured to act together with an arm having a terminal part of a third type, the third securing means being housed in a second notch formed in the base of the body and supported by a third flexible resilient pad which extends from an inner surface of one of the side walls of the body.

10. The member according to claim 9, wherein the opening, the first and second notches and the first and second resilient pads extend along the longitudinal orientation of the member.

11. The member according to claim 1, wherein the body comprises a first extremity through which it can be the body is inserted into each terminal part, and a second extremity opposite the first extremity.

12. The member according to claim 11, wherein the first securing means is closer to the first extremity of the body of the member and the second securing means.

13. The member according to claim 11, wherein the first, second and third securing means are aligned longitudinally between the first and second extremities.

14. The member according to claim 11, further comprising
a fourth securing means configured to act together with an arm having a terminal part of a fourth type, the fourth securing means being supported by at least one fourth resilient pad extending from the first extremity as a prolongation of at least one of the side walls of the body.

15. The member according to claim 11, further comprising a head formed at the second extremity of the member.

16. The member according to claim 15, wherein a housing receiving at least one of the terminal parts of the arms is located between the body and at least one lateral wing on the body issuing from the head.

17. The member according to claim 11, wherein the opening opens at the first extremity of the body.

18. A windscreen wiper assembly comprising a member according to claim 1.
